(19) United States
(12) Patent Application Publication
(10) Pub. No.: US 2022/0008272 A1
(43) Pub. Date: Jan. 13, 2022

(54) Novel Nursing Bed and Chair System

(71) Applicant: DONGGUANG LIU, Guangzhou (CN)

(72) Inventor: DONGGUANG LIU, Guangzhou (CN)

(21) Appl. No.: 16/632,415

(22) PCT Filed: Jul. 30, 2019
(86) PCT No.: PCT/CN2019/098426

§ 371 Date: Jan. 20, 2020

(30) Foreign Application Priority Data
Apr. 3, 2019 (CN) 201920451690.0

(51) Int. Cl. A61G 7/10

(52) U.S. Cl. CPC A61G 7/1098; A61G 7/1034; A61G 7/1076; A61G 7/1092; A61G 7/1094; A61G 7/1088

(57) ABSTRACT

The utility model discloses a novel nursing bed and chair system. The system includes a bed frame. The bed frame is provided with a backrest portion, a footrest portion and a cushion portion. The backrest portion and the footrest portion are connected to the cushion portion in a vertically rotatable manner, respectively. One end of the footrest portion, remote from the cushion portion, is provided with a foot pad portion. The foot pad portion is rotatably connected to the footrest portion. The system further includes a backrest push rod and a footrest push rod with outer housings being fixed to the bed frame. An actuator of the backrest push rod is fixedly connected to the back of the backrest portion. The outer housing of the footrest push rod is fixed to the bed frame, and an actuator of the footrest push rod is connected to a transmission mechanism. The transmission mechanism includes a transmission frame and an L-shaped support frame. One end of the transmission frame is rotatably connected to the bed frame, and the other end is rotatably connected to one end of the L-shaped support frame. The other end of the L-shaped support frame is connected to one end of the foot pad portion remote from the footrest portion. The actuator of the footrest push rod is fixedly connected to the transmission frame. By adopting the utility model, a higher degree of automation can be achieved.

### TECHNICAL FIELD

The utility model relates to nursing equipment, and in particular to a novel nursing bed and chair system.

### BACKGROUND

A nursing bed-chair transfer system is main nursing equipment mainly for transferring a paralyzed or bedridden patient, an elderly person, etc. from a bed to a wheelchair, and then taking to a toilet, a bathroom, etc, so as to restore the disability functions such as going to bed, getting out of bed, walking indoors, going to the toilet, and taking a bath, and will have a huge impact on the development of smart pensions and smart wards.

The nursing bed-chair transfer system mainly includes a backrest portion, a cushion portion and a footrest portion, which may be connected in a relatively rotatable manner. However, in the existing nursing bed-chair transfer system, a foot pad portion of the footrest portion generally cannot be automatically lifted and needs to be manually turned, which is not convenient and flexible to use.

### SUMMARY

In view of the shortcomings of the prior art, the utility model aims to provide a novel nursing bed and chair system, which can achieve a higher degree of automation.

In order to achieve the above objective, the utility model adopts the following technical solutions:

A novel nursing bed and chair system includes a bed frame, where the bed frame is provided with a backrest portion, a footrest portion and a cushion portion, the backrest portion and the footrest portion being connected to the cushion portion in a vertically rotatable manner, respectively; one end of the footrest portion, remote from the cushion portion, is provided with a foot pad portion, the foot pad portion being rotatably connected to the footrest portion; the system further includes a backrest push rod and a footrest push rod with outer housings being fixed to the bed frame; an actuator of the backrest push rod is fixedly connected to the back of the backrest portion; an actuator of the footrest push rod is connected to a transmission mechanism; the transmission mechanism includes a transmission frame and an L-shaped support frame, one end of the transmission frame is rotatably connected to the bed frame, and the other end is rotatably connected to one end of the L-shaped support frame; the other end of the L-shaped support frame is connected to one end of the foot pad portion remote from the footrest portion; and the actuator of the footrest push rod is fixedly connected to the transmission frame.

Further, the backrest portion includes a backrest transmission pad and a lateral backrest transmission mechanism, the footrest portion includes a footrest transmission pad and a lateral footrest transmission mechanism, and the cushion portion includes a cushion transmission pad and a lateral cushion transmission mechanism; the foot pad portion includes a foot pad transmission pad and a lateral foot pad transmission mechanism; the backrest transmission pad is arranged on the lateral backrest transmission mechanism in a sleeving manner, and the lateral backrest transmission mechanism may drive the backrest transmission pad to rotate laterally; the footrest transmission pad is arranged on the lateral footrest transmission mechanism in a sleeving manner, and the lateral footrest transmission mechanism may drive the footrest transmission pad to rotate laterally; the cushion transmission pad is arranged on the lateral cushion transmission mechanism in a sleeving manner, and the lateral cushion transmission mechanism may drive the cushion transmission pad to rotate laterally; the foot pad transmission pad is arranged on the lateral foot pad transmission mechanism in a sleeving manner, and the lateral foot pad transmission mechanism may drive the foot pad transmission pad to rotate laterally; and the lateral backrest transmission mechanism, the lateral footrest transmission mechanism, the lateral cushion transmission mechanism and the lateral foot pad transmission mechanism are rotatably connected by a universal joint.

Furthermore, the lateral backrest transmission mechanism, the lateral footrest transmission mechanism, the lateral cushion transmission mechanism and the lateral foot pad transmission mechanism all adopt roller mechanisms.

Further, one side of the bed frame is provided with a bedside armrest being turnable upward and downward.

Further, the back of the backrest portion is provided with a chair armrest being rotatable forward and backward.

Furthermore, the chair armrest includes a left armrest arm, a left armrest wrist, a left arm push rod, a right armrest arm, a right armrest wrist, and a right arm push rod; one end of the left armrest arm and one end of the right armrest arm are rotatably connected to the left and right sides of the back of the backrest portion through a left arm rotating shaft and a right arm rotating shaft, respectively; an actuator of the left arm push rod is vertically connected to one side of the left arm rotating shaft, and an actuator of the right arm push rod is vertically connected to one side of the right arm rotating shaft; and the left armrest wrist and the right armrest wrist are rotatably connected to the left armrest arm and the right armrest arm, respectively.

Furthermore, the chair armrest further includes a left wrist push rod and a right wrist push rod; the left armrest wrist and the right armrest wrist are rotatably connected to the other end of the left armrest arm and the other end of the right armrest arm through a left wrist rotating shaft and a right wrist rotating shaft, respectively; and the left wrist push rod and the right wrist push rod are vertically connected to one side of the left wrist rotating shaft and one side of the right wrist rotating shaft, respectively.

Further, the cushion portion is provided with a hip hole, a movable hip pad is arranged below the hip hole, and the movable hip pad is connected to a bed pan through the transmission mechanism; the transmission mechanism includes a rotating rod, an electric push rod and a rotating connection rod; a front end of the bed pan is rotatably connected to a lower end of the rotating rod, and an upper end of the rotating rod is fixedly connected to the movable hip pad; and an actuator of the electric push rod is connected to a lower end of the rotating connection rod, and an upper end of the rotating connection rod is fixedly connected to the movable hip pad.

The beneficial effects of the utility model are that the system of the utility model has a higher degree of automation, and has multiple functions, which can meet various needs of a patient or an elderly person, and has a great practical value for the development of smart pensions and smart wards.

### BRIEF DESCRIPTION OF FIGURES

FIG. 1 is a side structure diagram of an example of the utility model.

FIG. 2 is an exploded diagram of an example of the utility model.

FIG. 3 is a state diagram of a chair armrest in a chair form and a bed form according to an example of the utility model.

FIG. 4 is an exploded diagram of a chair armrest according to an example of the utility model.

FIG. 5 is a connection diagram of a bed pan, a transmission mechanism and a movable hip pad in an example of the utility model.

### DETAILED DESCRIPTION

The utility model will be further described below with reference to the accompanying drawings. It should be noted that on the premise of the technical solution, the present example gives detailed embodiments and specific operation processes, but the protection scope of the utility model is not limited to the present example.

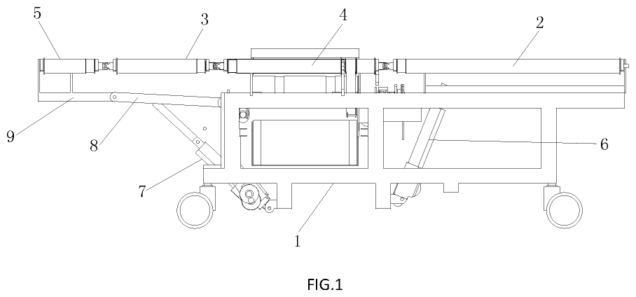

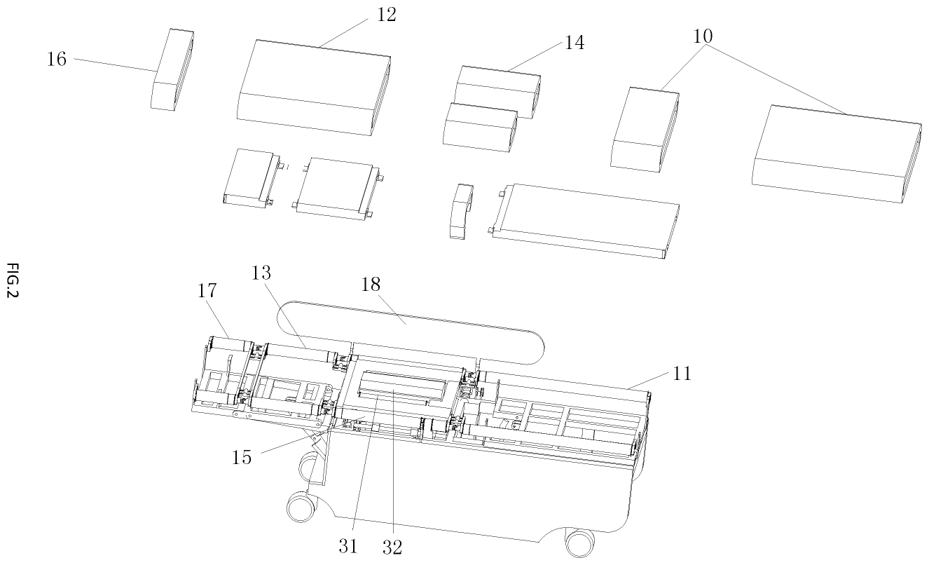

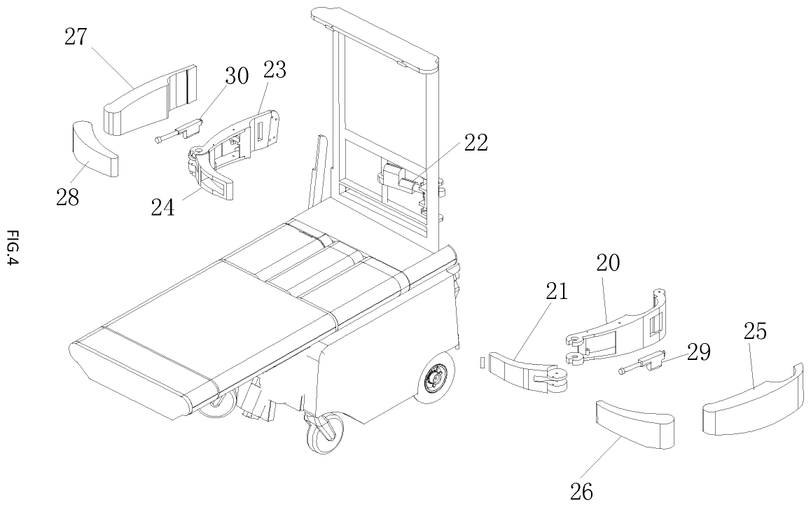

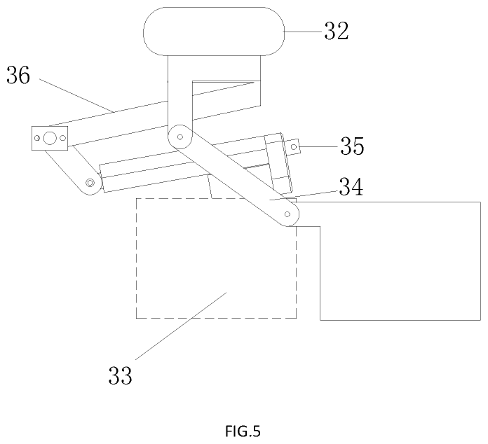

The present example provides a novel nursing bed and chair system, which includes, as shown in FIG. 1 to FIG. 5, a bed frame 1. The bed frame 1 is provided with a backrest portion 2, a footrest portion 3 and a cushion portion 4. The backrest portion 2 and the footrest portion 3 are connected to the cushion portion 4 in a vertically rotatable manner, respectively. One end of the footrest portion 3, remote from the cushion portion 4, is provided with a foot pad portion 5. The foot pad portion 5 is rotatably connected to the footrest portion 3. The system further includes a backrest push rod 6 and a footrest push rod 7 with outer housings being fixed to the bed frame 1. An actuator of the backrest push rod 6 is fixedly connected to the back of the backrest portion. An actuator of the footrest push rod 7 is connected to a transmission mechanism. The transmission mechanism includes a transmission frame 8 and an L-shaped support frame 9. One end of the transmission frame 8 is rotatably connected to the bed frame 1, and the other end is rotatably connected to one end of the L-shaped support frame 9. The other end of the L-shaped support frame 9 is connected to one end of the foot pad portion 5 remote from the footrest portion 3. The actuator of the footrest push rod 7 is fixedly connected to the transmission frame 8.

In the aforementioned novel nursing bed and chair system, when it is necessary to switch from a bed form to a chair form, the backrest push rod and the footrest push rod are activated, and the actuator of the backrest push rod pushes the backrest portion to rotate upward to an upright state and supports the backrest portion. The actuator of the footrest push rod pulls the transmission frame downward, and the transmission frame pulls the L-shaped support frame downward, thereby driving the foot pad portion and the footrest portion to move downward together. Since the transmission frame is rotatably connected to the L-shaped support frame, the transmission frame also rotates relative to the L-shaped support frame. Under the action of the L-shaped support frame, the foot pad portion and the footrest portion rotate relatively and are kept horizontal.

Further, the backrest portion 2 includes a backrest transmission pad 10 and a lateral backrest transmission mechanism 11, the footrest portion 3 includes a footrest transmission pad 12 and a lateral footrest transmission mechanism 13, and the cushion portion 4 includes a cushion transmission pad 14 and a lateral cushion transmission mechanism 15. The foot pad portion 5 includes a foot pad transmission pad 16 and a lateral foot pad transmission mechanism 17. The backrest transmission pad 10 is arranged on the lateral backrest transmission mechanism 11 in a sleeving manner, and the lateral backrest transmission mechanism 11 may drive the backrest transmission pad 10 to rotate laterally. The footrest transmission pad 12 is arranged on the lateral footrest transmission mechanism 13 in a sleeving manner, and the lateral footrest transmission mechanism 13 may drive the footrest transmission pad 12 to rotate laterally. The cushion transmission pad 14 is arranged on the lateral cushion transmission mechanism 15 in a sleeving manner, and the lateral cushion transmission mechanism 15 may drive the cushion transmission pad 14 to rotate laterally. The foot pad transmission pad 16 is arranged on the lateral foot pad transmission mechanism 17 in a sleeving manner, and the lateral foot pad transmission mechanism 17 may drive the foot pad transmission pad 16 to rotate laterally. The lateral backrest transmission mechanism 11, the lateral footrest transmission mechanism 13, the lateral cushion transmission mechanism 15 and the lateral foot pad transmission mechanism 17 are rotatably connected by a universal joint.

When a patient or an elderly person needs to be transferred to another bed and chair system, the lateral backrest transmission mechanism, the lateral footrest transmission mechanism, the lateral cushion transmission mechanism and the lateral foot pad transmission mechanism are activated. The lateral backrest transmission mechanism, the lateral footrest transmission mechanism, the lateral cushion transmission mechanism and the lateral foot pad transmission mechanism drive the backrest transmission pad 10, the footrest transmission pad 12, the cushion transmission pad 14 and the foot pad transmission pad 16 to rotate laterally, respectively, so as to transfer the patient or the elderly person to another bed and chair system in a rolling manner.

Furthermore, the lateral backrest transmission mechanism, the lateral footrest transmission mechanism, the lateral cushion transmission mechanism and the lateral foot pad transmission mechanism all adopt roller mechanisms. The backrest transmission pad 10, the footrest transmission pad 12, the cushion transmission pad 14 and the foot pad transmission pad 16 may adopt sponge transmission pads.

Further, one side of the bed frame 1 is provided with a bedside armrest 18 that is turnable upward and downward.

Further, the back of the backrest portion 2 is provided with a chair armrest 19 that is rotatable forward and backward.

Furthermore, the chair armrest 19 includes a left armrest arm 20, a left armrest wrist 21, a left arm push rod 22, a right armrest arm 23, a right armrest wrist 24, and a right arm push rod (not shown in the figure). One end of the left armrest arm 20 and one end of the right armrest arm 23 are rotatably connected to the left and right sides of the back of the backrest portion 2 through a left arm rotating shaft and a right arm rotating shaft, respectively. An actuator of the left arm push rod 22 is vertically connected to one side of the left arm rotating shaft, and an actuator of the right arm push rod is vertically connected to one side of the right arm rotating shaft. The left armrest wrist 21 and the right armrest wrist 24 are rotatably connected to the left armrest arm 20 and the right armrest arm 23, respectively.

In the present example, the left armrest arm, left armrest wrist, the right armrest arm and the right armrest wrist are respectively equipped with a left armrest arm cover 25, a left armrest wrist cover 26, a right armrest arm cover 27 and a right armrest wrist cover 28 in a matching manner.

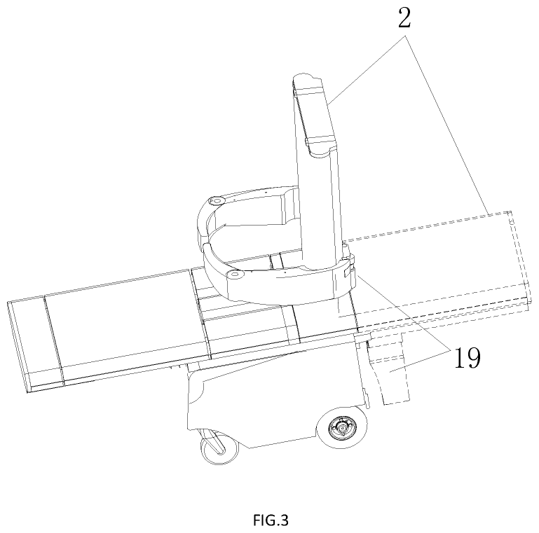

When being switched to a chair form, if the backrest portion needs the chair armrest, the left arm push rod and the right arm push rod may be activated to push the left arm rotating shaft and the right arm rotating shaft to rotate forward respectively, so as to drive the left armrest arm and the right armrest arm to rotate forward. When the chair armrest is not needed, the left arm push rod and the right arm push rod are activated to push the left arm rotating shaft and the right arm rotating shaft to rotate in opposite directions respectively to be retracted to the back of the backrest portion. A solid line portion in FIG. 3 indicates a use state of the chair armrest in the chair form, and a dotted line portion indicates a state in which the chair armrest is stored in the bed form.

Furthermore, the chair armrest 19 further includes a left wrist push rod 29 and a right wrist push rod 30. The left armrest wrist 26 and the right armrest wrist 28 are rotatably connected to the other end of the left armrest arm 20 and the other end of the right armrest arm 23 through a left wrist rotating shaft and a right wrist rotating shaft, respectively. The left wrist push rod 29 and the right wrist push rod 30 are vertically connected to one side of the left wrist rotating shaft and one side of the right wrist rotating shaft, respectively. In the present example, the left wrist push rod and the right wrist push rod are stored between the left armrest arm cover and the left armrest arm and between the right armrest arm cover and the right armrest arm, respectively.

Similarly, when the left armrest wrist and the right armrest wrist are rotated, the left wrist push rod and the right wrist push rod are activated to drive the left wrist rotating shaft and the right wrist rotating shaft to rotate in corresponding directions respectively, so as to drive the left armrest wrist and the right armrest wrist to rotate in corresponding directions.

Further, the cushion portion 4 is provided with a hip hole 31, a movable hip pad 32 is arranged below the hip hole 31, and the movable hip pad 32 is connected to a bed pan 33 through the transmission mechanism. The transmission mechanism includes a rotating rod 34, an electric push rod 35 and a rotating connection rod 36. A front end of the bed pan 33 is rotatably connected to a lower end of the rotating rod 34, and an upper end of the rotating rod 34 is fixedly connected to the movable hip pad 32. An actuator of the electric push rod 35 is connected to a lower end of the rotating connection rod 36, and an upper end of the rotating connection rod 36 is fixedly connected to the movable hip pad 32.

When a patient or an elderly person needs to excrete, the electric push rod is driven to be activated, and the electric push rod pulls backward the rotating connection rod, thereby driving the movable hip pad to move backward. The movable hip pad drives the upper end of the rotating rod to move backward, and the lower end of the rotating rod rotates forward to drive the bed pan to move forward to be below the hip hole, so that the excrement of the patient or the elderly person can be collected.

For those skilled in the art, various corresponding variations and modifications can be given according to the above technical solutions and concepts, and all these variations and modifications should be included in the protection scope of the claims of the utility model.

What is claimed is:

1. A novel nursing bed and chair system, comprising a bed frame, wherein the bed frame is provided with a backrest portion, a footrest portion and a cushion portion, the backrest portion and the footrest portion being connected to the cushion portion in a vertically rotatable manner, respectively; one end of the footrest portion, remote from the cushion portion, is provided with a foot pad portion, the foot pad portion being rotatably connected to the footrest portion; the system further comprises a backrest push rod and a footrest push rod with outer housings being fixed to the bed frame; an actuator of the backrest push rod is fixedly connected to the back of the backrest portion; an actuator of the footrest push rod is connected to a transmission mechanism; the transmission mechanism comprises a transmission frame and an L-shaped support frame, one end of the transmission frame is rotatably connected to the bed frame, and the other end is rotatably connected to one end of the L-shaped support frame; the other end of the L-shaped support frame is connected to one end of the foot pad portion remote from the footrest portion; and the actuator of the footrest push rod is fixedly connected to the transmission frame.

2. The novel nursing bed and chair system according to claim 1, wherein the backrest portion comprises a backrest transmission pad and a lateral backrest transmission mechanism, the footrest portion comprises a footrest transmission pad and a lateral footrest transmission mechanism, and the cushion portion comprises a cushion transmission pad and a lateral cushion transmission mechanism; the foot pad portion comprises a foot pad transmission pad and a lateral foot pad transmission mechanism; the backrest transmission pad is arranged on the lateral backrest transmission mechanism in a sleeving manner, and the lateral backrest transmission mechanism may drive the backrest transmission pad to rotate laterally; the footrest transmission pad is arranged on the lateral footrest transmission mechanism in a sleeving manner, and the lateral footrest transmission mechanism may drive the footrest transmission pad to rotate laterally; the cushion transmission pad is arranged on the lateral cushion transmission mechanism in a sleeving manner, and the lateral cushion transmission mechanism may drive the cushion transmission pad to rotate laterally; the foot pad transmission pad is arranged on the lateral foot pad transmission mechanism in a sleeving manner, and the lateral foot pad transmission mechanism may drive the foot pad transmission pad to rotate laterally; and the lateral backrest transmission mechanism, the lateral footrest transmission mechanism, the lateral cushion transmission mechanism and the lateral foot pad transmission mechanism are rotatably connected by a universal joint.

3. The novel nursing bed and chair system according to claim 2, wherein the lateral backrest transmission mechanism, the lateral footrest transmission mechanism, the lateral cushion transmission mechanism and the lateral foot pad transmission mechanism all adopt roller mechanisms.

4. The novel nursing bed and chair system according to claim 1, wherein one side of the bed frame is provided with a bedside armrest being turnable upward and downward.

5. The novel nursing bed and chair system according to claim 1, wherein the back of the backrest portion is provided with a chair armrest being rotatable forward and backward.

6. The novel nursing bed and chair system according to claim 5, wherein the chair armrest comprises a left armrest arm, a left armrest wrist, a left arm push rod, a right armrest arm, a right armrest wrist, and a right arm push rod; one end of the left armrest arm and one end of the right armrest arm are rotatably connected to the left and right sides of the back of the backrest portion through a left arm rotating shaft and a right arm rotating shaft, respectively; an actuator of the left arm push rod is vertically connected to one side of the left arm rotating shaft, and an actuator of the right arm push rod is vertically connected to one side of the right arm rotating shaft; and the left armrest wrist and the right armrest wrist are rotatably connected to the left armrest arm and the right armrest arm, respectively.

7. The novel nursing bed and chair system according to claim 6, wherein the chair armrest further comprises a left wrist push rod and a right wrist push rod; the left armrest wrist and the right armrest wrist are rotatably connected to the other end of the left armrest arm and the other end of the right armrest arm through a left wrist rotating shaft and a right wrist rotating shaft, respectively; and the left wrist push rod and the right wrist push rod are vertically connected to one side of the left wrist rotating shaft and one side of the right wrist rotating shaft, respectively.

8. The novel nursing bed and chair system according to claim 1, wherein the cushion portion is provided with a hip hole, a movable hip pad is arranged below the hip hole, and the movable hip pad is connected to a bed pan through the transmission mechanism; the transmission mechanism comprises a rotating rod, an electric push rod and a rotating connection rod; a front end of the bed pan is rotatably connected to a lower end of the rotating rod, and an upper end of the rotating rod is fixedly connected to the movable hip pad; and an actuator of the electric push rod is connected to a lower end of the rotating connection rod, and an upper end of the rotating connection rod is fixedly connected to the movable hip pad.
